(19) United States
(12) Patent Application Publication
(10) Pub. No.: US 2019/0359134 A1
(43) Pub. Date: Nov. 28, 2019

(54) PERIPHERY MONITORING DEVICE

(71) Applicant: Aisin Seiki Kabushiki Kaisha, Kariya-shi (JP)

(72) Inventors: Kinji Yamamoto, Anjo-shi (JP); Kazuya Watanabe, Anjo-shi (JP); Tetsuya Maruoka, Okazaki-shi (JP)

(73) Assignee: Aisin Seiki Kabushiki Kaisha, Kariya-shi (JP)

(21) Appl. No.: 16/414,158

(22) Filed: May 16, 2019

(30) Foreign Application Priority Data
May 24, 2018 (JP) 2018-099975

(51) Int. Cl. B60R 1/00; B62D 15/02

(52) U.S. Cl. CPC B60R 1/003; B60R 2300/8066; B60R 2300/105; B62D 15/021

(57) ABSTRACT

A periphery monitoring device includes: an image acquisition unit sequentially acquiring an image based on a captured image obtained by imaging a rear region of a towing vehicle to which a towed vehicle is connectable; an information acquisition unit acquiring similar point information satisfying a condition in one or more local regions with respect to the images; a search region setting unit setting turning search regions at an angular interval in a vehicle width direction about a connection element for connecting the towed vehicle to the towing vehicle with respect to the acquired similar point information; and an angle detection unit detecting an angle corresponding to the turning search region in which a count value is maximum when a number of pieces of the similar point information is counted among the turning search regions as a connection angle of the towed vehicle with respect to the towing vehicle.

### CROSS REFERENCE TO RELATED APPLICATIONS

This application is based on and claims priority under 35 U.S.C. § 119 to Japanese Patent Application 2018-099975, filed on May 24, 2018, the entire contents of which are incorporated herein by reference.

### TECHNICAL FIELD

Embodiments of this disclosure relate to a periphery monitoring device.

### BACKGROUND DISCUSSION

In the related art, a towing vehicle (tractor) that tows a towed vehicle (trailer) is known. A towing device including, for example, a tow bracket and a coupling ball (hitch ball) is provided on the rear of the towing vehicle, and a towed device (coupler) is provided on the tip of the towed vehicle. Then, by connecting the hitch ball to the coupler, the towing vehicle is able to tow the towed vehicle with a turning movement. The connection angle of the towed vehicle which varies with respect to the towing vehicle is important for a driver of the towing vehicle to perform a driving operation of the towing vehicle and to perform various automatic control operations or a notification processing. Conventionally, there has been known a system which detects such a connection angle of the towed vehicle by, for example, imaging a target mark attached to the front surface of the towed vehicle with a camera provided on the rear of the towing vehicle and recognizing the target mark by an image processing. See, for example, US-A-2014/0188344 (Reference 1) and US-A-2014/0200759 (Reference 2).

In the case of the related art, it is necessary to attach the target mark to the towed vehicle in order to detect the connection angle of the towed vehicle, and this is troublesome. In addition, when the periphery of the target mark is dark or when the target mark is dirty, the system may not be able to accurately recognize the target mark, which may make it impossible to detect an accurate connection angle. Therefore, it is significant to be able to provide a periphery monitoring device capable of detecting the connection angle of the towed vehicle with high accuracy without requiring preparation work for detection of the connection angle of the towed vehicle.

### SUMMARY

A periphery monitoring device according to an aspect of this disclosure includes, for example, an image acquisition unit configured to sequentially acquire an image based on a captured image obtained by imaging a rear region of a towing vehicle that is captured by an imaging unit provided in the towing vehicle to which a towed vehicle is able to be connected, an information acquisition unit configured to acquire similar point information that satisfies a predetermined condition in one or more local regions with respect to a plurality of the images acquired in time series, a search region setting unit configured to set a plurality of turning search regions at a predetermined angular interval in a vehicle width direction about a connection element by which the towed vehicle is connected to the towing vehicle with respect to the acquired similar point information, and an angle detection unit configured to detect an angle corresponding to the turning search region in which a count value is maximum when a number of pieces of the similar point information is counted among the plurality of turning search regions as a connection angle of the towed vehicle with respect to the towing vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view schematically illustrating an example of a connected state of a towing vehicle equipped with a periphery monitoring device and a towed vehicle according to an embodiment;

FIG. 2 is a top view schematically illustrating the example of the connected state of the towing vehicle equipped with the periphery monitoring device and the towed vehicle according to the embodiment;

FIG. 3 is an exemplary block diagram of a configuration of a periphery monitoring system including the periphery monitoring device according to the embodiment;

FIG. 4 is an exemplary block diagram of a configuration of a periphery monitoring processing unit included in a CPU of the periphery monitoring device according to the embodiment;

FIG. 5 is an exemplary and schematic view of an actual image captured by an imaging unit of the periphery monitoring system according to the embodiment;

FIG. 6 is a schematic view illustrating an example of moving point information (optical flow) as similar point information that is used when detecting a connection angle using the periphery monitoring device according to the embodiment;

FIG. 7 is a schematic view illustrating an example of a turning search region that is used when detecting the connection angle by the periphery monitoring device according to the embodiment;

FIG. 8 is a schematic view illustrating an example of an angular range of a directional group in a case where moving point information (optical flow) as similar point information is classified for each movement direction by the periphery monitoring device according to the embodiment;

FIG. 9 is a schematic view illustrating an example of a histogram generated by classifying moving point information (optical flow) as similar point information into directional groups based on a movement direction in the periphery monitoring device according to the embodiment;

FIG. 10 is a schematic view illustrating an example of a detailed turning search region that is used when detecting a detailed connection angle by the periphery monitoring device according to the embodiment;

FIG. 11 is a schematic view illustrating an example of a search target image in which the detailed turning search region is divided into a first divided image and a second divided image so that the first divided image and the second divided image are displayed for easy comparison in the periphery monitoring device according to the embodiment;

FIG. 12 is a schematic view illustrating an example in which an evaluation mark indicating similarity between the first divided image and the second divided image is displayed in the search target image of FIG. 11;

FIG. 13 is an exemplary schematic view explaining that a plurality of types of widths of the detailed turning search region exists in the periphery monitoring device according to the embodiment;

FIG. 14 is a flowchart explaining an example of the procedure of a connection angle detection processing by the periphery monitoring device according to the embodiment;

FIG. 15 is a flowchart illustrating a detailed example of an initial detection mode processing in the flowchart of FIG. 14;

FIG. 16 is a flowchart illustrating a detailed example of a tracking detection mode processing in the flowchart of FIG. 14;

FIG. 17 is a schematic view illustrating an example of detecting a detailed connection angle using evaluation lines based on positions at which similar points exist when comparing the first divided image and the second divided image with each other, FIG. 17 being a schematic view illustrating a case where the detailed connection angle is not employed as a connection angle; and

FIG. 18 is a schematic view illustrating an example of detecting a detailed connection angle using evaluation lines based on positions at which similar points exist when comparing the first divided image and the second divided image with each other, FIG. 18 being a schematic view illustrating a case where the detailed connection angle is employed as a connection angle.

### DETAILED DESCRIPTION

Hereinafter, an exemplary embodiment disclosed here will be disclosed. A configuration of the embodiment described later and actions, results, and effects provided by the configuration are given by way of example. The disclosure may be realized by a configuration other than the configuration disclosed in the following embodiment and may obtain at least one of various effects based on a basic configuration and derivative effects.

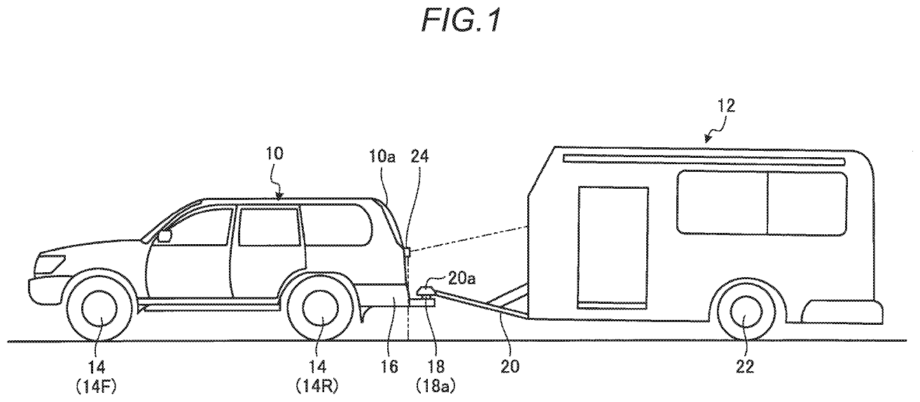

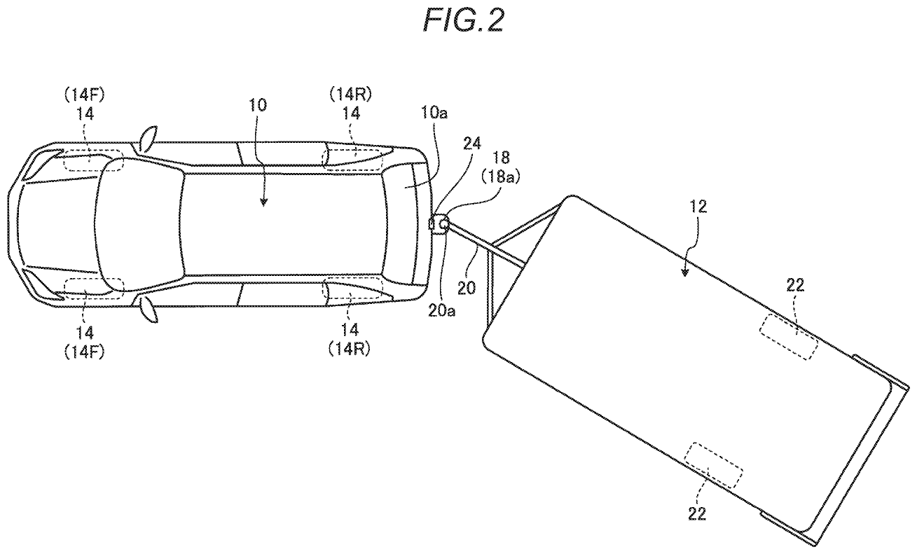

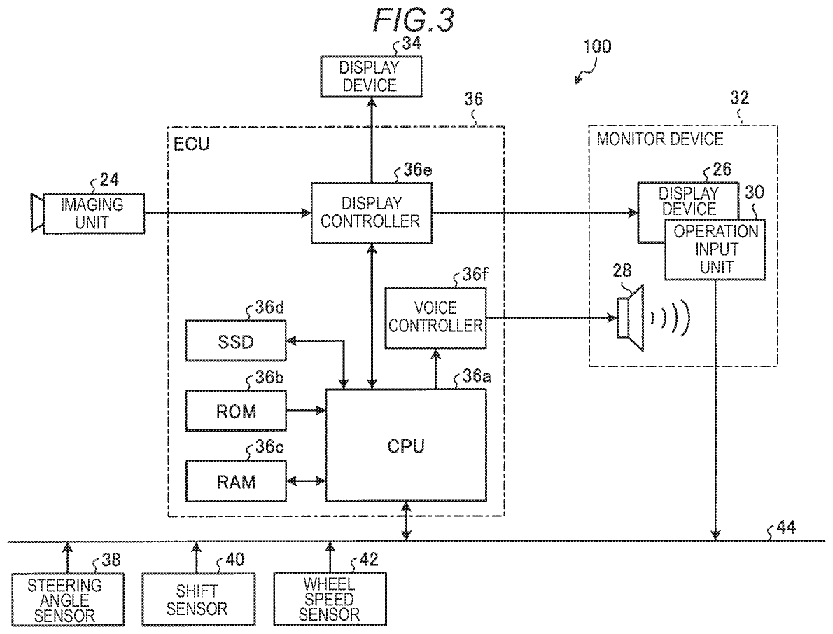

FIG. 1 is a side view illustrating a towing vehicle 10 equipped with a periphery monitoring device and a towed vehicle 12 to be towed by the towing vehicle 10 according to an embodiment. In FIG. 1, the left direction in the drawing is set to the front on the basis of the towing vehicle 10, and the right direction in the drawing is set to the rear on the basis of the towing vehicle 10. FIG. 2 is a top view of the towing vehicle 10 and the towed vehicle 12 illustrated in FIG. 1. In addition, FIG. 3 is an exemplary block diagram of a configuration of a periphery monitoring system 100 including the periphery monitoring device mounted on the towing vehicle 10.

The towing vehicle 10 may be, for example, an automobile having an internal combustion engine (engine, not illustrated) as a drive source (i.e., an internal combustion engine vehicle), may be an automobile having an electric motor (not illustrated) as a drive source (e.g., an electric automobile or a fuel cell automobile), or may be an automobile having both the internal combustion engine and the electric motor as a drive source (i.e., a hybrid automobile). The towing vehicle 10 may be a sport utility vehicle (SUV) as illustrated in FIG. 1, or may be a so-called “pickup truck” in which a loading platform is provided at the rear side of the vehicle. In addition, the towing vehicle 10 may be a general passenger car. The towing vehicle 10 may be equipped with any of various transmissions, and may be equipped with various devices (e.g., systems or parts) required to drive the internal combustion engine or the electric motor. In addition, for example, the types, the number, and the layout of devices related to the driving of wheels 14 (front wheels 14F and rear wheels 14R) in the towing vehicle 10 may be set in various ways.

A towing device 18 (hitch) protrudes from, for example, a center lower portion in the vehicle width direction of a rear bumper 16 of the towing vehicle 10 to tow the towed vehicle 12. The towing device 18 is fixed, for example, to a frame of the towing vehicle 10. As an example, the towing device 18 includes a hitch ball 18a (connection element) which is vertically installed (in the vehicle vertical direction) and has a spherical tip end, and the hitch ball 18a is covered with a coupler 20a which is provided on the tip end of a connection member 20 fixed to the towed vehicle 12. As a result, the towing vehicle 10 and the towed vehicle 12 are connected to each other, and the towed vehicle 12 may be swung (turned) in the vehicle width direction with respect to the towing vehicle 10. That is, the hitch ball 18a transmits forward, backward, leftward and rightward movements to the towed vehicle 12 (the connection member 20) and also receives acceleration or deceleration power.

The towed vehicle 12 may be, for example, of a box type including at least one of a cabin space, a residential space, and a storage space, for example, as illustrated in FIG. 1, or may be of a loading platform type in which a luggage (e.g., a container or a boat) is loaded. The towed vehicle 12 illustrated in FIG. 1 includes a pair of trailer wheels 22 as one example. The towed vehicle 12 illustrated in FIG. 1 is a driven vehicle that includes driven wheels but not includes driving wheels or steered wheels.

An imaging unit 24 is provided on a lower wall portion of a rear hatch 10a on the rear side of the towing vehicle 10. The imaging unit 24 is, for example, a digital camera that incorporates an imaging element such as a charge coupled device (CCD) or a CMOS image sensor (CIS). The imaging unit 24 may output video image data (captured image data) at a predetermined frame rate. The imaging unit 24 includes a wide-angle lens or a fisheye lens and is capable of imaging, for example, a range from 140° to 220° in the horizontal direction. In addition, the optical axis of the imaging unit 24 is set obliquely downward. Thus, the imaging unit 24 sequentially captures an image of a region including the rear end of the towing vehicle 10, the connection member 20, and at least the front end of the towed vehicle 12 (e.g., the range indicated by a two-dot chain line, see FIG. 1) and outputs the image as captured image data. The captured image data obtained by the imaging unit 24 may be used for recognition of the towed vehicle 12 and detection of a connection state (e.g., a connection angle or the presence or absence of connection) of the towing vehicle 10 and the towed vehicle 12. In this case, the connection state or the connection angle between the towing vehicle 10 and the towed vehicle 12 may be acquired based on the captured image data obtained by the imaging unit 24 without mounting a dedicated detection device. As a result, a system configuration may be simplified, and the load of an arithmetic processing or an image processing may be reduced.

As illustrated in FIG. 3, for example, a display device 26 and a voice output device 28 are provided in a vehicle room of the towing vehicle 10. The display device 26 is, for example, a liquid crystal display (LCD) or an organic electroluminescent display (OLED). The voice output device 28 is a speaker as an example. In addition, in the present embodiment, as an example, the display device 26 is covered with a transparent operation input unit 30 (e.g., a touch panel). A driver (user) may visually perceive a video (image) displayed on the screen of the display device 26 through the operation input unit 30. In addition, the driver may execute an operation input (instruction input) by operating the operation input unit 30 with a finger, for example, via touching, pushing, or movement of a position corresponding to the video (image) displayed on the screen of the display device 26. In addition, in the present embodiment, as an example, the display device 26, the voice output device 28, or the operation input unit 30 is provided in a monitor device 32 which is positioned on the central portion in the vehicle width direction (the transverse direction) of a dashboard. The monitor device 32 may include an operation input unit (not illustrated) such as a switch, a dial, a joystick, or a push button. In addition, another voice output device (not illustrated) may be provided at another position in the vehicle room different from the monitor device 32, and voice may be output from the voice output device 28 of the monitor device 32 and the other voice output device. In addition, in the present embodiment, the monitor device 32 is also used as a navigation system or an audio system as an example, but a dedicated monitor device for the periphery monitoring device may be provided separately from these systems.

When the towed vehicle 12 is connected to the towing vehicle 10, the periphery monitoring system 100 may detect a connection angle between the towing vehicle 10 and the towed vehicle 12. The periphery monitoring system 100 notifies the driver of the connection state between the towing vehicle 10 and the towed vehicle 12 based on the detected connection angle. The periphery monitoring system 100 may display, for example, on the display device 26, a trailer icon corresponding to the towed vehicle 12 indicating that the towed vehicle 12 is connected. In this case, an own vehicle icon indicating the towing vehicle 10 and the trailer icon indicating the towed vehicle 12 may be displayed, and the connection angle between the towing vehicle 10 and the towed vehicle 12 may be displayed by a connection state of the own vehicle icon and the trailer icon. In addition to this display, for example, the connection angle may be displayed as numerical values. In addition, the periphery monitoring system 100 may estimate a movement direction (turning direction) of the towed vehicle 12 based on the detected connection angle when the towing vehicle 10 connected to the towed vehicle 12 moves backward. In this case, the periphery monitoring system 100 may display a predicted movement line of the towed vehicle 12 on the display device 26, or may display the trailer icon at a predicted movement position. Thus, the periphery monitoring system 100 has a function of accurately detecting the connection angle of the towed vehicle 12 with respect to the towing vehicle 10 in order to perform, for example, prediction of movement of the towed vehicle 12 as described above. Details of the detection of the connection angle will be described later.

A display device 34 different from the display device 26 may be provided in the vehicle room of the towing vehicle 10. The display device 34 may be provided, for example, in an instrument cluster section of a dashboard. The screen of the display device 34 may be smaller than the screen of the display device 26. The display device 34 may simply display the trailer icon, a mark, or a message indicating the towed vehicle 12 which is displayed when the towed vehicle 12 connected to the towing vehicle 10 may be recognized, or may display details of the connection angle (e.g., numerical values). The amount of information displayed on the display device 34 may be smaller than the amount of information displayed on the display device 26. The display device 34 is, for example, an LCD or an OELD. In addition, the display device 34 may be configured with an LED, or the like.

In addition, in the periphery monitoring system 100 (periphery monitoring device), in addition to an electronic control unit (ECU) 36 or the monitor device 32, for example, a steering angle sensor 38, a shift sensor 40, and a wheel speed sensor 42 are electrically connected via an in-vehicle network 44 as an electric telecommunication line. The in-vehicle network 44 is configured as, for example, a controller area network (CAN). The ECU 36 may receive detection results of the steering angle sensor 38, the shift sensor 40, and the wheel speed sensor 42, for example, or an operational signal of the operation input unit 30, for example, via the in-vehicle network 44, and may reflect the results in control.

The ECU 36 includes, for example, a central processing unit (CPU) 36a, a read only memory (ROM) 36b, a random access memory (RAM) 36c, a solid state drive (SSD) (flash memory) 36d, a display controller 36e, and a voice controller 36f. For example, the CPU 36a may execute various control operations and arithmetic processings such as a processing of displaying the trailer icon based on the connection angle as well as a display processing associated with images displayed on the display devices 26 and 34, a processing of recognizing (detecting) the towed vehicle 12 connected to the towing vehicle 10, and a processing of detecting the connection angle between the towing vehicle 10 and towed vehicle 12. The CPU 36a may read out programs installed and stored in a non-volatile storage device such as the ROM 36b and may execute arithmetic processings according to the programs. The RAM 36c temporarily stores various data used in the arithmetic processings in the CPU 36a. In addition, the display controller 36e mainly executes, for example, combination of image data displayed on the display devices 26 and 34 among the arithmetic processings in the ECU 36. In addition, the voice controller 36f mainly executes a processing of voice data output from the voice output device 28 among the arithmetic processings in the ECU 36. In addition, the SSD 36d is a rewritable non-volatile storage unit, and may store data even when a power of the ECU 36 is turned off. For example, the CPU 36a, the ROM 36b, and the RAM 36c may be integrated in the same package. In addition, the ECU 36 may be configured to use another logical arithmetic processor such as a digital signal processor (DSP) or a logic circuit, for example, instead of the CPU 36a. In addition, a hard disk drive (HDD) may be provided instead of the SSD 36d, and the SSD 36d or the HDD may be provided separately from the ECU 36.

The steering angle sensor 38 is, for example, a sensor that detects the amount of steering of a steering unit such as a steering wheel of the towing vehicle 10 (a steering angle of the towing vehicle 10). The steering angle sensor 38 is configured using, for example, a Hall element. The ECU 36 acquires, for example, the amount of steering of the steering unit by the driver or the amount of steering of each wheel 14 at the time of automatic steering from the steering angle sensor 38 and executes various control operations. The steering angle sensor 38 also detects a rotation angle of a rotating element included in the steering unit.

The shift sensor 40 is, for example, a sensor that detects the position of a movable element of a shift operation unit (e.g., a shift lever). The shift sensor 40 may detect the position of a lever, an arm, or a button, for example, as the movable portion. The shift sensor 40 may include a displacement sensor, or may be configured as a switch. When the periphery monitoring system 100 notifies the connection angle between the towing vehicle 10 and the towed vehicle 12, the steering angle may be displayed as the state of the towing vehicle 10, or whether the current state is a forward movement state or a backward movement state may further be displayed. In this case, it is possible to allow the user to recognize the state of the towing vehicle 10 and the towed vehicle 12 in more detail.

The wheel speed sensor 42 is a sensor that detects the amount of rotation or the number of revolutions per unit time of the wheel 14. The wheel speed sensor 42 is disposed on each wheel 14 and outputs a wheel speed pulse number indicating the number of revolutions detected from each wheel 14 as a sensor value. The wheel speed sensor 42 may be configured, for example, using a Hall element. The ECU 36 calculates the amount of movement of the towing vehicle 10, for example, based on the sensor value acquired from the wheel speed sensor 42 and executes various control operations. When the vehicle speed of the towing vehicle 10 is calculated based on the sensor value from each wheel speed sensor 42, the CPU 36a determines the vehicle speed of the towing vehicle 10 based on the speed of the wheel 14 having the smallest sensor value among four wheels and executes various control operations. In addition, when there is the wheel 14 having a sensor value larger than that of the other wheels 14 among four wheels, for example, when there is the wheel 14 having a larger number of revolutions per unit period (unit time or unit distance) than those of the other wheels 14 by a predetermined value or more, the CPU 36a regards the wheel 14 as being in a slip state (idle state) and executes various control operations. In addition, the wheel speed sensor 42 may be provided in a brake system (not illustrated). In that case, the CPU 36a may acquire the detection result of the wheel speed sensor 42 via the brake system. The vehicle speed acquired by the sensor value of the wheel speed sensor 42 is also used when determining whether or not an optical flow to be described later may be acquired.

The configuration, arrangement, and electrical connection, for example, of the various sensors described above are merely given by way of example and may be set (changed) in various ways.

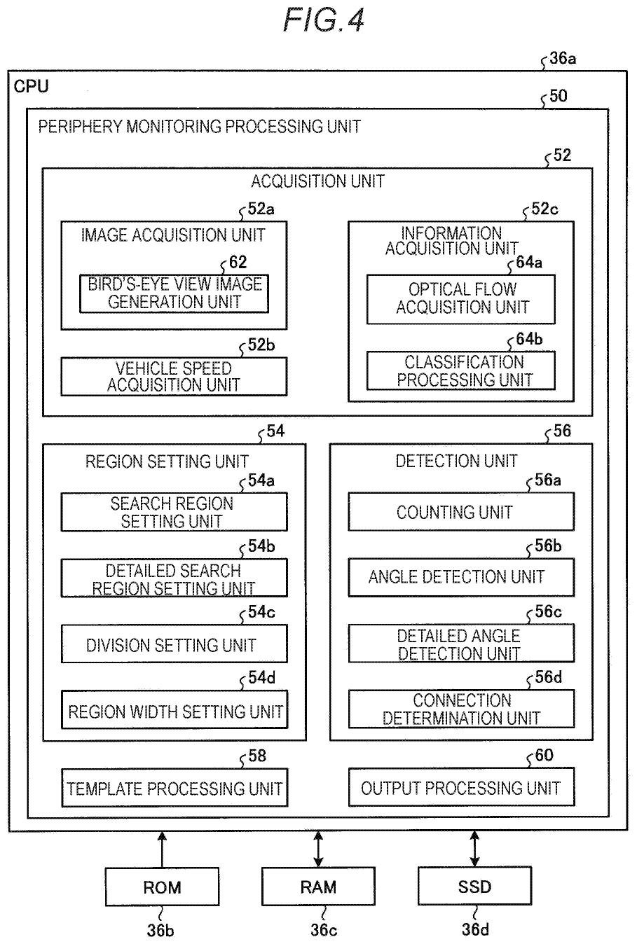

FIG. 4 is a block diagram exemplarily and schematically illustrating a configuration of a periphery monitoring processing unit 50 realized in the CPU 36a included in the ECU 36. The CPU 36a reads out a program installed and stored in the storage device such as the ROM 36b and executes the program to realize the periphery monitoring processing unit 50 as a module for detecting the connection angle of the towed vehicle 12 connected to the towing vehicle 10. The periphery monitoring processing unit 50 further includes an acquisition unit 52, a region setting unit 54, a detection unit 56, a template processing unit 58, and an output processing unit 60, for example, as detailed modules.

The acquisition unit 52 executes a processing of collecting various pieces of information necessary to detect the connection angle between the towing vehicle 10 and the towed vehicle 12. The acquisition unit 52 includes, for example, an image acquisition unit 52a, a vehicle speed acquisition unit 52b, and an information acquisition unit 52c.

The image acquisition unit 52a acquires a rear image (image of a rear region) of the towing vehicle 10 captured by the imaging unit 24 provided on the rear of the towing vehicle 10. In addition, the image acquisition unit 52a includes a bird's-eye view image generation unit 62. The bird's-eye view image generation unit 62 performs a known viewpoint conversion processing on the captured image data obtained by the imaging unit 24 to generate, for example, a bird's-eye view image (bird's-eye view image data) of a region between the towing vehicle 10 and the towed vehicle 12 viewed from above.

The vehicle speed acquisition unit 52b acquires the vehicle speed of the towing vehicle 10 (the towed vehicle 12) based on the sensor value (e.g., an integrated value of the wheel speed pulse number) provided from the wheel speed sensor 42. In another embodiment, the vehicle speed acquisition unit 52b may calculate the vehicle speed based on the rear image acquired by the image acquisition unit 52a and captured by the imaging unit 24 or an image (a front image or a lateral image) captured by an imaging unit provided on another position, for example, the front side or the lateral side of the towing vehicle 10. Thus, the vehicle speed acquisition unit 52b is an example of an “own vehicle movement state acquisition unit” that acquires own vehicle movement information indicating that the towing vehicle 10 is moving.

The information acquisition unit 52c acquires similar point information for detecting the connection angle based on the image data acquired by the image acquisition unit 52a or classifies the similar point information to acquire secondary information. The information acquisition unit 52c includes, for example, an optical flow acquisition unit 64a and a classification processing unit 64b.

The optical flow acquisition unit 64a acquires (calculates) optical flows as similar point information that satisfies a predetermined condition in one or more local regions based on the bird's-eye view image data generated by the bird's-eye view image generation unit 62. The optical flows are, for example, similar point information indicating the motion of an object (an attention point or a feature point) reflected in a bird's-eye view by a vector. When calculating optical flows of the connection member 20 and the periphery of the connection member 20 in a case where the towing vehicle 10 connected to the towed vehicle 12 is traveling, a portion corresponding to the towed vehicle 12 and the connection member 20 which move integrally with the towing vehicle 10 acquires optical flows as stop point information indicating substantially a stop state. On the other hand, a portion other than the towing vehicle 10, the towed vehicle 12, and the connection member 20 (e.g., a road surface which is a moving portion) acquires optical flows as moving point information indicating a moving state. Thus, by detecting the optical flow state, the position at which the connection member 20 exists, i.e., the connection angle between the towing vehicle 10 and the towed vehicle 12 on the basis of the hitch ball 18a may be detected.

The towed vehicle 12 (or the connection member 20) may be turned about the hitch ball 18a. Thus, the connection member 20 may be moved in the turning direction when the towed vehicle 12 is turning or when, for example, vibration is generated based on a road surface condition and the like. In this case, an optical flow indicates a vector in the turning direction except a case where the towing vehicle 10 and the towed vehicle 12 exhibit the same behavior, a so-called “balanced state.” That is, optical flows may be calculated as moving point information having a length in the circumferential direction on a concentric orbit centered on the hitch ball 18a. In the present embodiment, optical flows (moving point information) indicating movement over a predetermined length or less along the concentric orbit centered on the hitch ball 18a (connection element) are also recognized as optical flows indicating the position at which the connection member 20 exists, similar to optical flows (stop time point information) indicating substantially a stop state. In this case, when calculating the optical flow, the predetermined length may be determined based on the length of movement in the circumferential direction at an acquisition interval (time) of bird's-eye view image data to be compared.

The classification processing unit 64b classifies optical flows in a direction along the concentric orbit among the optical flows calculated by the optical flow acquisition unit 64a, and excludes a so-called noise flow that is not related to the detection of the connection angle. That is, the classification processing unit 64b increases the efficiency and accuracy of a detection processing when estimating the position at which the connection member 20 exists. As described above, when the towed vehicle 12 is turning, the optical flow corresponding to the position at which the connection member 20 exists indicates a vector directed in the circumferential direction on the concentric orbit centered on the hitch ball 18a. As described above, the optical flow acquisition unit 64a calculates optical flows by comparing the latest bird's-eye view image data generated by the bird's-eye view image generation unit 62 with bird's-eye view image data generated in the past (e.g., 100 ms before). At this time, a noise flow which is directed in the circumferential direction but directed in a direction different from the turning direction may be included. The noise flow occurs, for example, when different feature points on the road surface are erroneously recognized as the same feature points. The direction of such a noise flow varies in various ways. Conversely, optical flows corresponding to the turning connection member 20 are directed in substantially the same direction. Thus, by counting the number of optical flows (the number of existent optical flows) directed in the same direction and setting the optical flows in the direction with the largest count value to a detection processing target of the connection angle, the noise flow may be eliminated and the efficiency and accuracy of the detection processing may be increased.

The region setting unit 54 sets a turning search region which is a processing target region in a case of counting the number of optical flows, for example, when detecting the connection angle between the towing vehicle 10 and the towed vehicle 12. The region setting unit 54 includes, for example, a search region setting unit 54a, a detailed search region setting unit 54b, a division setting unit 54c, and a region width setting unit 54d.

The search region setting unit 54a sets a plurality of turning search regions at a predetermined interval (e.g., at an interval of 1° in the range of ±80°) in the turning direction about the hitch ball 18a when detecting the connection angle between the towing vehicle 10 and the towed vehicle 12 based on the optical flows calculated by the optical flow acquisition unit 64a. For example, a rectangular turning search region (region of interest: ROI) is set. The position at which the connection member 20 exists, i.e., the connection angle may be acquired by selecting a turning search region which includes the largest number of optical flows in a stop state (stop point information) and optical flows having a predetermined length or less which are directed in the circumferential direction on the concentric orbit (moving point information) from among the plurality of turning search regions set at the predetermined interval.

The detailed search region setting unit 54b sets a plurality of detailed turning search regions at an interval finer than the turning search regions set by the search region setting unit 54a based on the detected connection angle for a correction processing that further improves the accuracy of the connection angle detected based on the turning search regions set by the search region setting unit 54a. For example, when the connection angle detected using the turning search regions set by the search region setting unit 54a is “20°,” the detailed search region setting unit 54b sets the detailed turning search regions on the basis of “20°,” for example, at an interval of 0.1° in the range of 20°±5° about the hitch ball 18a. Then, the connection angle may be detected with higher accuracy by selecting one detailed turning search region from among the plurality of detailed turning search regions.

The division setting unit 54c sets division of a search target image defined by each detailed turning search region into a first divided image and a second divided image when each detailed turning search region is superimposed on the bird's-eye view image generated by the bird's-eye view image generation unit 62. The division setting unit 54c divides the search target image into the first divided image and the second divided image, for example, along a division line that passes through the hitch ball 18a (connection element) and extends in the longitudinal direction of the detailed turning search region. The connection member 20 (connection bar) which interconnects the towing vehicle 10 and the towed vehicle 12 is often formed bilaterally symmetrically in consideration of tow balance. Thus, when the division line of the detailed turning search region coincides with the longitudinal center line of the connection member 20, the first divided image and the second divided image are likely to have the same shape. That is, by comparing the first divided image with the second divided image to evaluate bilateral symmetry (similarity) thereof and detecting the detailed turning search region in which the symmetry evaluation value indicating symmetry is maximum, it may be estimated that the angle corresponding to the detailed turning search region is the connection angle (detailed connection angle) of the towed vehicle 12 with respect to the towing vehicle 10. The determination of similarity may use a known similarity calculation method such as SSD (a method using the square of a pixel value difference), SAD (a method using the multiply of the absolute value of a pixel value difference), or NCC (normalized cross correlation).

The region width setting unit 54d sets a plurality of types of widths of the detailed turning search regions set by the detailed search region setting unit 54b in the direction of the concentric orbit centered on the hitch ball 18a (connection element). The towed vehicle 12 connected to the towing vehicle 10 is of a box type or a loading platform type, for example, according to the application thereof as described above. In addition, there are various sizes or shapes of the towed vehicle 12, and the shape or size of the connection member 20 is also different according to the towed vehicle 12. Thus, when the division setting unit 54c divides the detailed turning search region into the first divided image and the second divided image, an image in the width direction of the connection member 20 as a target may be contained in the detailed turning search region. By containing the image of the connection member 20 in the detailed turning search region, the accuracy of determination of the symmetry between the first divided image and the second divided image may be improved.

The detection unit 56 detects, for example, the connection angle between the towing vehicle 10 and the towed vehicle 12 and the presence or absence of connection of the towed vehicle 12 based on the calculation result of the optical flows or the evaluation result of bilateral symmetry. The detection unit 56 includes, for example, a counting unit 56a, an angle detection unit 56b, a detailed angle detection unit 56c, and a connection determination unit 56d.

The counting unit 56a applies the turning search region set by the search region setting unit 54a to the optical flows calculated by the optical flow acquisition unit 64a, and counts how many optical flows indicating the connection member 20 exist in each turning search region. That is, the counting unit 56a counts the number of optical flows (stop point information) indicating a stop state and the number of optical flows (moving point information) having a predetermined length or less indicating movement in the circumferential direction on the concentric orbit centered on the hitch ball 18a. In addition, the counting unit 56a counts the number of symmetry evaluation values (symmetrical points or evaluation marks) indicating bilateral symmetry via comparison between the first divided image and the second divided image divided by the division setting unit 54c.

The angle detection unit 56b extracts the turning search region having the largest count value based on the number of optical flows indicating the connection member 20 counted by the counting unit 56a. Then, the angle detection unit 56b determines an angle corresponding to the extracted turning search region as the connection angle of the towed vehicle 12 with respect to the towing vehicle 10.

In addition, the detailed angle detection unit 56c determines the angle corresponding to the detailed turning search region in which the number of symmetry evaluation values (symmetry points or evaluation marks) counted by the counting unit 56a is maximum as a detailed connection angle of the towed vehicle 12 with respect to the towing vehicle 10. That is, by correcting the connection angle determined by the angle detection unit 56b to the angle based on the detailed turning search region that is further subdivided, a more detailed connection angle is detected.

The connection determination unit 56d determines that the towed vehicle 12 is not connected to the towing vehicle 10 when the count value of optical flows counted by the counting unit 56a is less than or equal to a predetermined threshold value in any of the plurality of turning search regions. That is, disconnection of the towed vehicle 12 may be detected in a processing of detecting the connection angle between the towing vehicle 10 and the towed vehicle 12 without providing a dedicated sensor and the like.

The template processing unit 58 registers, as a template, the result of the connection angle detected at this time, i.e., an image (shape) of the connection member 20 reflected in the turning search region indicating the connection angle of the connection member 20 (connection bar), for example, in the storage unit such as the RAM 36c or the SSD 36d. Since a processing of detecting the connection angle is successively executed within a short cycle, it may be considered that a difference between the connection angle detected in this detection processing and the connection angle detected in a next detection processing is small. Thus, when executing the next detection processing of the connection angle, the angle detection unit 56b performs a matching processing between an image of the connection member 20 reflected in the turning search region that is newly set by the search region setting unit 54a and an image of the connection member 20 reflected in the template based on the stored detection result of the previous time, and selects the turning search region having the highest degree of similarity. Then, the angle corresponding to the selected turning search region is set to the latest connection angle. As described above, by performing the matching processing using the template, the connection angle may be detected with the same accuracy without using the optical flows, and the processing load may be reduced. When detecting the connection angle using the template, the template processing unit 58 updates, as a new template, registration of the image (shape) of the connection member 20 reflected in the turning search region at the time of detecting the connection angle in the ROM 36b or the SSD 36d. Then, the angle detection unit 56b uses the latest template in a next connection angle detection processing.

The output processing unit 60 outputs the connection angle detected by the detection unit 56 to another in-vehicle control unit or control system. For example, the output processing unit 60 provides connection angle information to the display controller 36e when the orientation (inclination) of the trailer icon with respect to the own vehicle icon is displayed or when the connection state of the towed vehicle 12 is displayed in real time. In addition, the output processing unit 60 also provides the connection angle information to the voice controller 36f when the towed vehicle 12 is in a so-called “jack knife” state.

The above-described modules such as the acquisition unit 52, the region setting unit 54, the detection unit 56, the template processing unit 58, and the output processing unit 60 are classified for each function for the sake of convenience, and may be classified in more detail, and several modules among these may be integrated. Similarly, for example, the image acquisition unit 52a, the vehicle speed acquisition unit 52b, the information acquisition unit 52c, the search region setting unit 54a, the detailed search region setting unit 54b, the division setting unit 54c, the region width setting unit 54d, the counting unit 56a, the angle detection unit 56b, the detailed angle detection unit 56c, and the connection determination unit 56d are classified for each function for the sake of convenience, and may be classified in more detail, and several modules among these may be integrated.

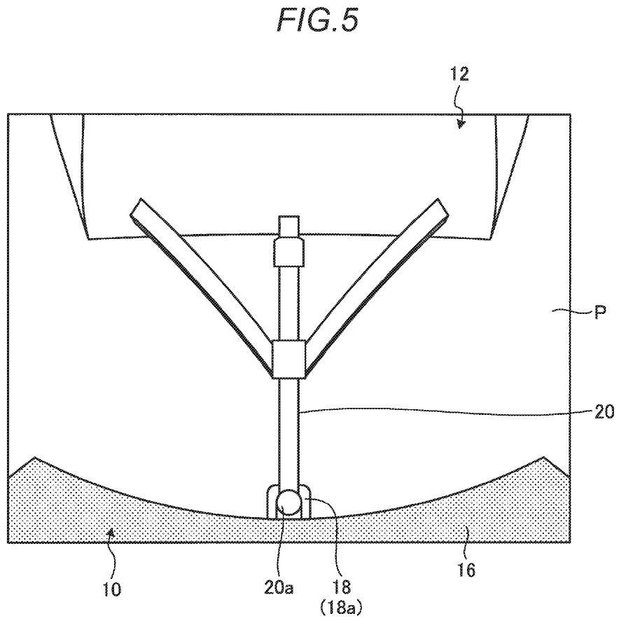

An operation of each component of the periphery monitoring processing unit 50 configured as described above will be described in more detail with reference to FIGS. 5 to 13.

The image acquisition unit 52a acquires a rear image (image of a rear region) of the towing vehicle 10 captured by the imaging unit 24 provided on the rear of the towing vehicle 10. The imaging unit 24 is fixed on the rear of the towing vehicle 10 so that the imaging direction or the imaging range thereof is fixed. Therefore, as illustrated in FIG. 5, for example, the rear bumper 16 or the towing device 18 (the hitch ball 18a) of the towing vehicle 10 is reflected at a predetermined position (in a region at the lower end side of FIG. 5) of an image P captured by the imaging unit 24. In addition, when the towed vehicle 12 is connected to the towing vehicle 10, in the image P, a partial front portion of the towed vehicle 12 and the connection member 20 (the coupler 20a) are reflected in a predetermined region on the basis of the rear bumper 16 and the like. In addition, FIG. 5 illustrates a state where the towed vehicle 12 is positioned directly behind the towing vehicle 10.

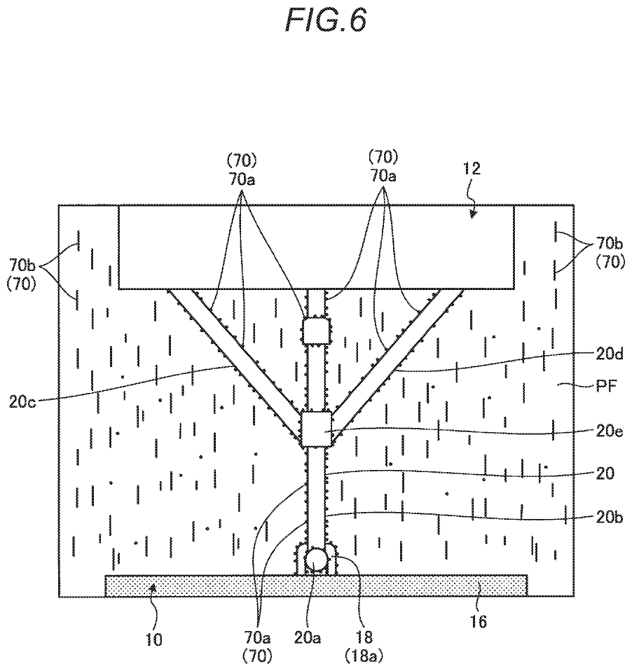

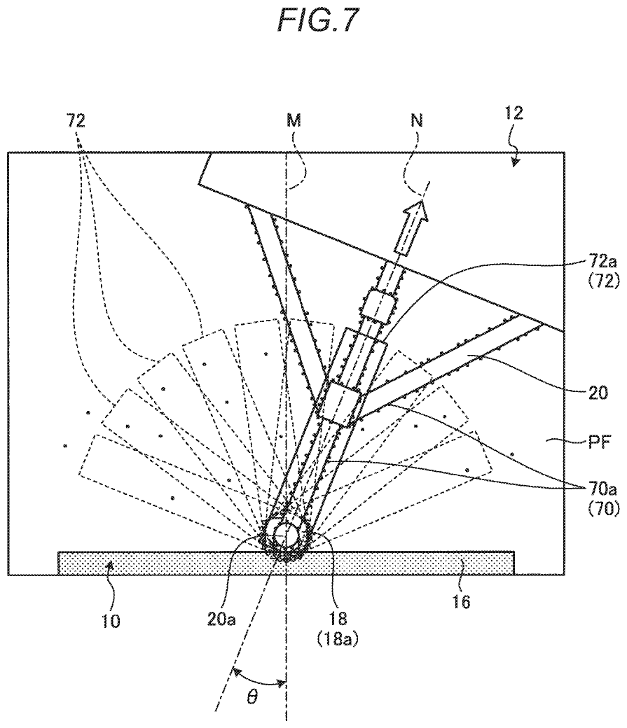

The image acquisition unit 52a performs a viewpoint conversion processing on the captured image data acquired from the imaging unit 24 using the bird's-eye view image generation unit 62 to generate a bird's-eye view image (bird's-eye view image data) of the region between the towed vehicle 12 and the towing vehicle 10 viewed from directly above, for example, as illustrated in FIG. 6 or FIG. 7. Then, the image acquisition unit 52a provides the data to another module for detection of the connection angle. When generating the bird's-eye view image data, the bird's-eye view image generation unit 62 generates, for example, bird's-eye view image data on the basis of the height of the hitch ball 18a. By generating the bird's-eye view image data on the basis of the height of the hitch ball 18a, it is possible to calculate optical flows at the height of the connection member 20 of the towed vehicle 12 to be detected. As a result, the direction in which the optical flow is directed or the magnitude of movement may be accurately determined, and the accuracy of detection of the connection angle may be improved. In addition, when the imaging unit 24 is not provided immediately above the hitch ball 18a, for example, when the imaging unit 24 is provided offset to any direction in the vehicle width direction, the connection member 20 as a detection target is perspectively viewed. In this case, for example, when the bird's-eye view image data is generated on the basis of the road surface, the connection member 20 is projected on the road surface, and the connection angle on the image may deviate from an actual connection angle. On the other hand, when the bird's-eye view image data is generated on the basis of the height of the hitch ball 18a, the connection angle on the image and the actual connection angle are prevented from deviating from each other, and the connection angle may be accurately detected.

In another embodiment, the image P (an actual image as illustrated in FIG. 5) based on captured image data acquired from the imaging unit 24 may be provided to another module as data for the detection of the connection angle. When using the bird's eye image data, the processing load is increased compared to a case of using an actual image, but it is possible to more accurately detect the vector direction of the optical flow (similar point information) or the amount of movement, and the accuracy of detection of the connection angle may be improved.

FIG. 6 is an exemplary and schematic view illustrating the concept of optical flows 70 (similar point information) calculated by the optical flow acquisition unit 64a with respect to a bird's-eye view image PF generated by the bird's-eye view image generation unit 62. When the connection member 20 and the towed vehicle 12 are connected to the towing vehicle 10, the movement of the towing vehicle 10, the towed vehicle 12, and the connection member 20 is restricted in the traveling direction of the towing vehicle 10. Therefore, as illustrated in FIG. 6, the optical flows 70 on the connection member 20 are not basically moved. Thus, the optical flows 70 on the connection member 20 (the coupler 20a, a main bar 20b, sidebars 20c and 20d, and a bracket 20e) are substantially calculated as points or short flows 70a having a predetermined length or less (the amount of movement within a predetermined value). On the other hand, the optical flows 70 of a portion other than the towing vehicle 10, the towed vehicle 12, and the connection member 20, for example, the optical flows 70 on the road surface in FIG. 6 are displayed as long flows 70b having a length depending on the amount of movement of the towing vehicle 10 which are directed in the movement direction of the towing vehicle 10. That is, it may be estimated that the connection member 20 exists at the position at which the short flows 70a exist. In addition, in FIG. 6, the display of optical flows of a portion corresponding to the towing vehicle 10 (the rear bumper 16) and the towed vehicle 12 (main body) is omitted.

In a case of an example illustrated in FIG. 6, the optical flows 70 are calculated for the entire bird's-eye view image PF. In another embodiment, the optical flow acquisition unit 64a may calculate the optical flows 70 only in a specific region of the bird's-eye view image PF. For example, since the imaging unit 24 is fixed to the towing vehicle 10, the position of the towing device 18 (the hitch ball 18a) in the bird's-eye view image PF is constant, and the position of the connection member 20 connected to the hitch ball 18a may be roughly estimated in consideration of a turning range. Thus, the optical flow acquisition unit 64a may calculate the optical flows 70 only for the region in which the connection member 20 may be turned. In addition, in another embodiment, the optical flow acquisition unit 64a may calculate only the short flows 70a when calculating the optical flows 70. The vector length of the long flows 70b may be estimated based on the time interval of two bird's-eye view image data to be compared when calculating the speed of the towing vehicle 10 and the optical flows. Thus, the optical flow acquisition unit 64a may exclude the optical flows 70 having a predetermined length or more and the optical flows 70 directed in the movement direction of the towing vehicle 10 when calculating the optical flows 70. Thus, by limiting the optical flows 70 to be calculated, the load of a counting processing of the counting unit 56a may be reduced.

As illustrated in FIG. 7, a plurality of turning search regions 72 are set by the search region setting unit 54a with respect to the bird's-eye view image PF for which the optical flows 70 have been calculated as described above. Then, the counting unit 56a counts the number of short flows 70a included in each turning search region 72. In FIG. 7, a case where a turning search region 72a includes the largest number of short flows 70a is illustrated. Thus, the angle detection unit 56b estimates that the angle corresponding to the turning search region 72a among the turning search regions 72 is the angle in which the connection member 20 exists, i.e., the connection angle θ of the connection member 20. In this case, the connection angle θ is an acute angle formed by a vehicle center line M that passes through the hitch ball 18a and extends in the longitudinal direction of the towing vehicle 10 and a member center line N that extends in the longitudinal direction of the connection member 20. Although the interval of the turning search regions illustrated in FIG. 7 is roughly illustrated for convenience of illustration, for example, the interval may be set to “1° ” in the range in which the connection member 20 may be turned leftward or rightward.

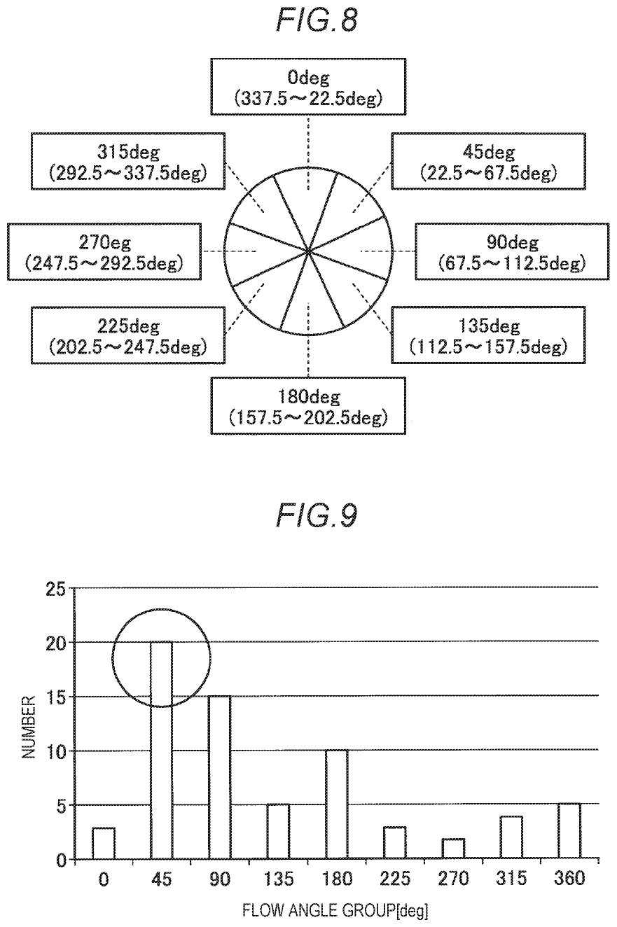

As described above, when the towed vehicle 12 is turning or when the towed vehicle 12 moves to the left or right due to vibration, the short flows 70a are illustrated as vectors that are directed in the circumferential direction on the concentric orbit centered on the hitch ball 18a. In this case, as described above, noise flows similar to the short flows 70a may exist in a portion other than the portion corresponding to the connection member 20. Since the noise flows are directed in various directions, for example, the classification processing unit 64b classifies the short flows 70a into a plurality of directional groups by angular division as illustrated in FIG. 8. In FIG. 8, an example of classifying the short flows 70a into eight sections including a section 0 deg, a section 45 deg, a section 90 deg, a section 135 deg, a section 180 deg, a section 225 deg, a section 270 deg, and a section 315 deg at the interval of 45 deg as directional groups is illustrated. Thus, it may be estimated that the short flows 70a belonging to the section in which the largest number of short flows 70a directed to a specific direction exist are optical flows to be referenced for detecting the connection angle of the connection member 20 other than noise flows. FIG. 9 is a histogram illustrating an example of classifying the short flows 70a according to the classification of FIG. 8. In FIG. 9, a case where the number of short flows 70a directed to the direction of 45 degrees is the largest, and therefore, the short flows 70a included in the section 45 deg are short flows 70a that are valid when detecting the connection angle of the connection member 20 is illustrated.

The counting unit 56a counts the number of short flows 70a (e.g., 45 degrees) included in the section 45 deg for each of the plurality of turning search regions set by the search region setting unit 54a. Then, the angle detection unit 56b detects the angle corresponding to the turning search region including the largest number of short flows 70a as the connection angle of the connection member 20. As described above, by classifying the short flows 70a by angular division, it is possible to extract the short flows 70a to be counted, which enables a reduction in the processing load of the counting unit 56a and may contribute to improvement in the reliability of the count value, i.e., the reliability of the connection angle owing to the exclusion of noise flows.

As described above, since the optical flow is calculated by comparing two captured image data (bird's-eye view image data) acquired at an extremely short time interval (e.g., 100 ms), variation in the accuracy of directional classification may occur. In order to cope with such a case, the counting unit 56a may count the short flows 70a (moving point information) included in a predetermined number of high-rank directional groups (sections) in which the number of movement directions included in the directional groups (sections) is large. In a case of FIG. 9, for example, the section 45 deg having the largest number of short flows and the section 90 deg having the secondly largest number of short flows are counting targets. As a result, it is possible to contribute to improvement in the accuracy of detection of the connection angle by counting of the short flows 70a while eliminating the noise flows. In addition, the number of directional groups (sections) as counting targets may be changed as appropriate, and there may be three or more sections or may be one section.

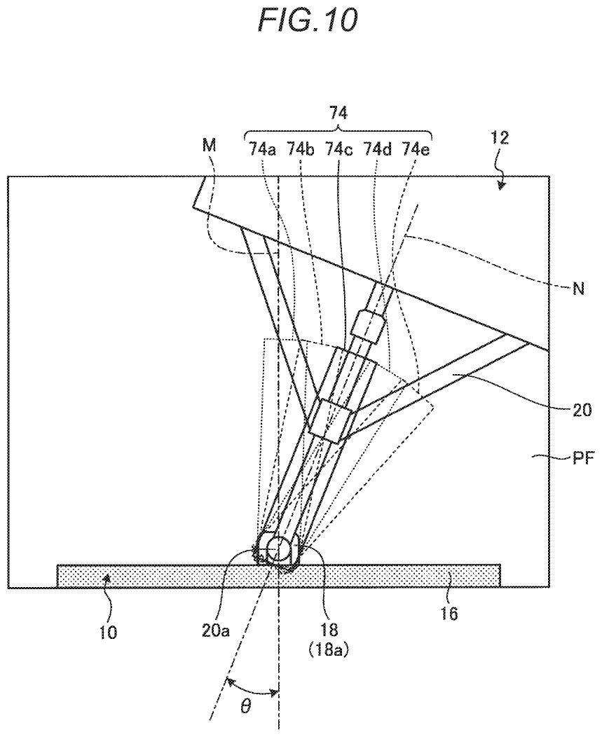

Next, a correction processing of further improving the accuracy of the connection angle detected based on the turning search region set by the search region setting unit 54a using a detailed turning search region 74 set by the detailed search region setting unit 54b will be described with reference to FIGS. 10 to 12.

In the turning search region 72 set by the search region setting unit 54a, for the convenience of counting of the optical flows 70, the angular interval is set relatively roughly to an interval of, for example, 1°. That is, the connection angle to be detected is also in the unit of 1°. Therefore, as illustrated in FIG. 10, the detailed angle detection unit 56c sets the detailed turning search region 74 to an angular interval (e.g., 0.1°) that is finer than the angular interval (e.g., 1°) of the turning search region 72 set by the search region setting unit 54a. Then, the set detailed turning search region 74 is divided by the division setting unit 54c, and the detection of the detailed connection angle (correction of the connection angle) is performed by determining the bilateral symmetry of an image.

FIG. 10 is an exemplary and schematic view in which the detailed turning search region 74 is set in the bird's-eye view image PF by the detailed search region setting unit 54b about the hitch ball 18a based on the connection angle detected by the angle detection unit 56b using the turning search region 72. Although the interval of the detailed turning search region 74 illustrated in FIG. 10 is roughly illustrated for convenience of illustration, for example, it is assumed that the interval is set to “0.1°,” for example, and that the setting range is, for example, the range of ±5° with respect to the connection angle detected by the angle detection unit 56b.

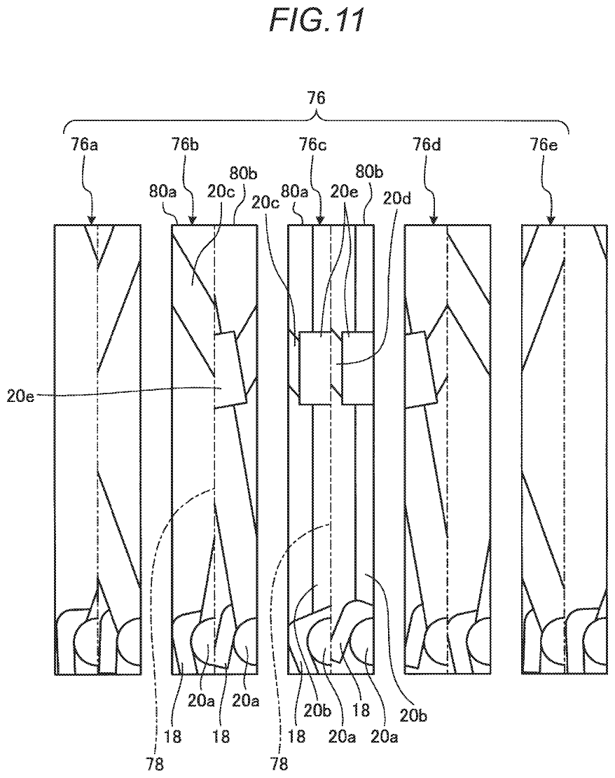

FIG. 11 is a view exemplarily and schematically illustrating a search target image 76 corresponding to the detailed turning search region 74 illustrated in FIG. 10. When each detailed turning search region 74 is superimposed on the bird's-eye view image PF, the division setting unit 54c divides the search target image 76 defined by each detailed turning search region 74 into a first divided image 80a and a second divided image 80b by a division line 78 which passes through the hitch ball 18a (connection element) and extends in the longitudinal direction of the detailed turning search region 74. FIG. 11 illustrates only the search target image 76 (76a to 76e) corresponding to the detailed turning search region 74 (74a to 74e) illustrated in FIG. 10 for convenience of illustration. In practice, for example, a plurality of search target images 76 corresponding to the number of detailed turning search regions 74 set at the interval of “0.1° ” are to be evaluated.

FIG. 11 illustrates an example of evaluation of the bilateral symmetry of the first divided image 80a and the second divided image 80b in which, when the division setting unit 54c divides the detailed turning search region 74 into the first divided image 80a and the second divided image 80b, one of the first divided image 80a and the second divided image 80b is inverted about the division line 78 as an axis. As described above, the connection member 20 (connection bar) that interconnects the towing vehicle 10 and the towed vehicle 12 is often formed bilaterally symmetrically in consideration of tow balance. Thus, when the division line 78 of the search target image 76 coincides with the longitudinal center line of the connection member 20, the first divided image 80a and the second divided image 80b are likely to have the same shape. That is, it may be determined that the similarity (symmetry) of the first divided image 80a and the second divided image 80b is high.

For example, in the search target image 76c, the content in which a portion corresponding to the coupler 20a, the main bar 20b, the bracket 20e, and the sidebar 20c included in the first divided image 80a and a portion corresponding to the coupler 20a, the main bar 20b, the bracket 20e, and the sidebar 20d included in the second divided image 80b have high similarity (symmetry) is illustrated. On the other hand, the sidebar 20c appears in the first divided image 80a of the search target image 76b, but the sidebar 20d does not appear at a symmetrical position with respect to the sidebar 20c in the second divided image 80b. In addition, the bracket 20e that appears in the second divided image 80b does not appear in the first divided image 80a. That is, it may be determined that the similarity (symmetry) of the first divided image 80a and the second divided image 80b is low.

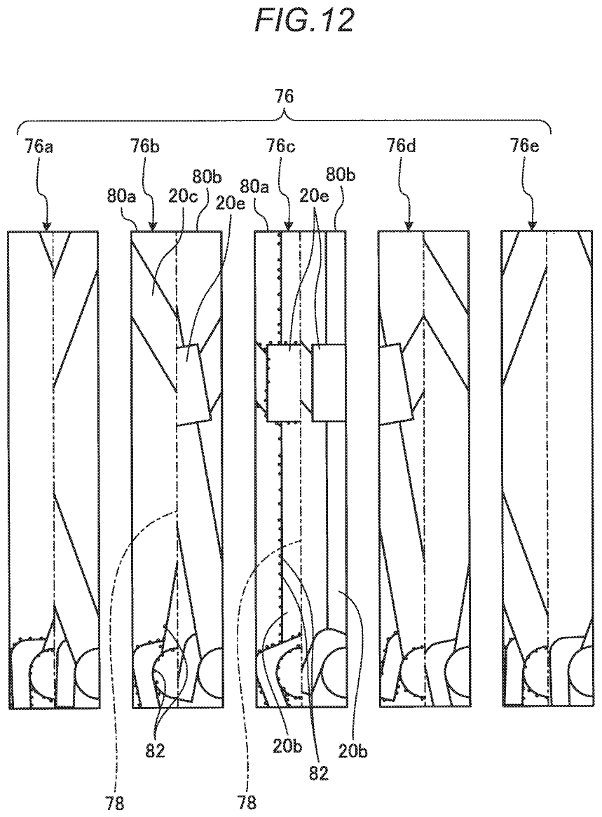

FIG. 12 illustrates an example in which the detailed angle detection unit 56c evaluates the symmetry between one inverted image (second divided image 80b) and the other non-inverted image (first divided image 80a) and attaches an evaluation mark 82 to a position that is evaluated as having symmetry. As described above, the search target image 76c has many portions with high symmetry between the first divided image 80a and the second divided image 80b, and a large number of evaluation marks 82 are attached thereto. On the other hand, except for the search target image 76c, the number of portions with high symmetry between the first divided image 80a and the second divided image 80b is small, and the number of evaluation marks 82 is small. That is, since the search target image 76c having the largest count value of the evaluation mark 82 has a high possibility that the division line 78 and the longitudinal center line of the connection member 20 coincide with each other, the detailed angle detection unit 56c may estimate that the angle of the detailed turning search region 74c corresponding to the search target image 76c is the connection angle of the connection member 20. Thus, the detailed angle detection unit 56c corrects, for example, the connection angle in the unit of 1° detected by the angle detection unit 56b to the detailed connection angle in the unit of 0.1°, and detects the corrected detailed connection angle. The determination of similarity may be executed using a known similarity calculation method such as SSD, SAD, or NCC.

When detecting the connection angle using the optical flows as described above, in a case where a horizontally asymmetrical appendage such as a handle is attached to the connection member 20, the short flow 70a also appears in that portion and becomes an evaluation target, thus causing deterioration in the accuracy of evaluation. On the other hand, when detecting the connection angle using bilateral symmetry, the influence of the asymmetrical appendage as described above may be eliminated or reduced. Thus, more reliable detailed detection of the connection angle is possible.

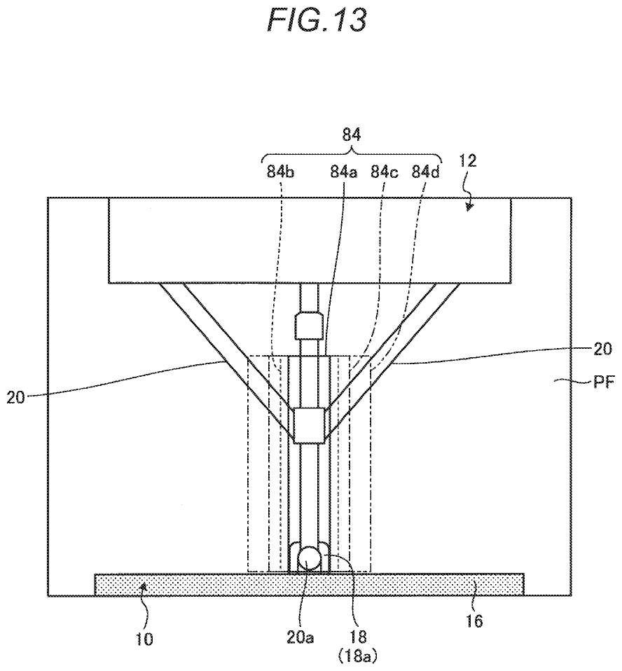

As illustrated in FIG. 11, when comparing the symmetry between the first divided image 80a and the second divided image 80b, an image in the width direction of the connection member 20 to be compared may be contained in the search target image 76, i.e., in the detailed turning search region. Thus, as illustrated in FIG. 13, the region width setting unit 54d sets a plurality of detailed turning search regions 84 having different sizes in the width direction of the connection member 20, for example, four types of detailed turning search regions 84a to 84d according to the type of the connection member 20 and the like. As a result, the image corresponding to the connection member 20 may be easily contained in the search target image 76, and the accuracy of determining the symmetry between the first divided image 80a and the second divided image 80b may be improved.

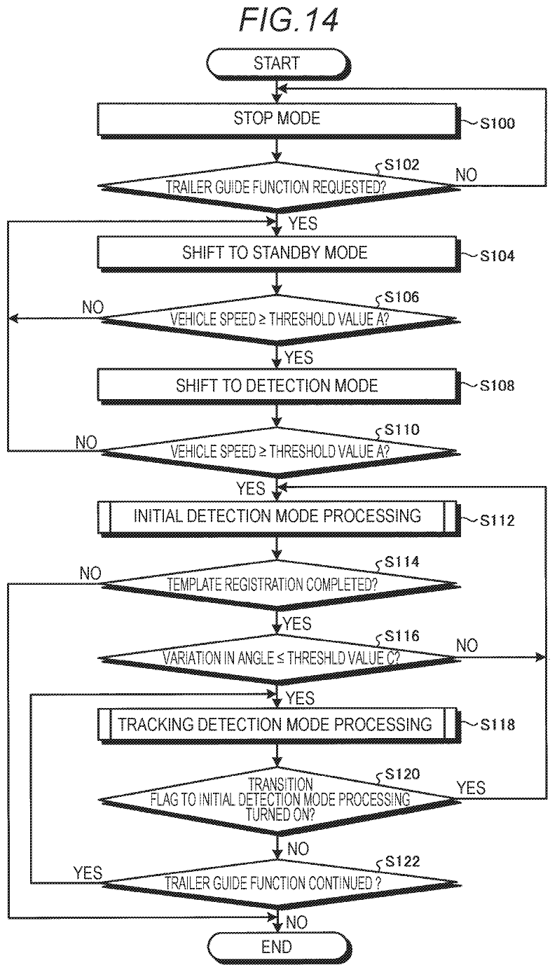

The procedure of a connection angle detection processing by the periphery monitoring processing unit 50 configured as described above will be described based on the flowcharts of FIGS. 14 to 16.

The periphery monitoring system 100 that monitors the connection state of the towed vehicle 12 is in a stop mode in the normal state (S100), and shifts to a standby mode (S104) when a user such as a driver performs a request operation that makes a trailer guide function be valid via, for example, the operation input unit 30 (Yes in S102). In the standby mode, for example, the display of the display area of the display device 26 changes from the navigation screen or the audio screen that is normally displayed in the stop mode to the screen that displays an actual image showing the rear of the towing vehicle 10 captured by the imaging unit 24. When the request operation is not performed (No in S102), the display device 26 that maintains the stop mode continuously displays the navigation screen or the audio screen.

In the standby mode, when the vehicle speed is less than a predetermined threshold value A (No in S106), for example, when the vehicle speed is less than 2 km/h, the flow returns to S104 and the standby mode is maintained. On the other hand, when the vehicle speed is equal to or greater than the predetermined threshold value A (Yes in S106), the periphery monitoring processing unit 50 shifts to a detection mode in which detection of the connection angle is performed (S108). In this case, the display area of the display device 26 is divided into, for example, two areas, and the actual image displayed in the standby mode is displayed on one divided screen (main screen) and a bird's-eye view image displaying an own vehicle icon or a trailer icon is displayed on the other divided screen (sub screen). As a result, the user can easily visually perceive that a processing of detecting the presence or absence of connection or the connection angle of the towed vehicle 12 is currently executed. When shifting to the detection mode, the periphery monitoring processing unit 50 mainly starts detection of the connection angle using the optical flows. As described above, it is necessary for the towing vehicle 10 to move as a detection condition of the connection angle using the optical flows. Then, the detection of the connection angle is especially needed when the towing vehicle 10 (towed vehicle 12) moves backward, and in this case, the towing vehicle 10 often travels at a low speed. Thus, prior to the start of an initial detection mode processing using the optical flows, the periphery monitoring processing unit 50 again confirms whether or not the vehicle speed is equal to or greater than the threshold value A, and shifts to S104 and returns to the standby mode when the vehicle speed falls below the threshold value A or the towing vehicle is stopped (No in S110).

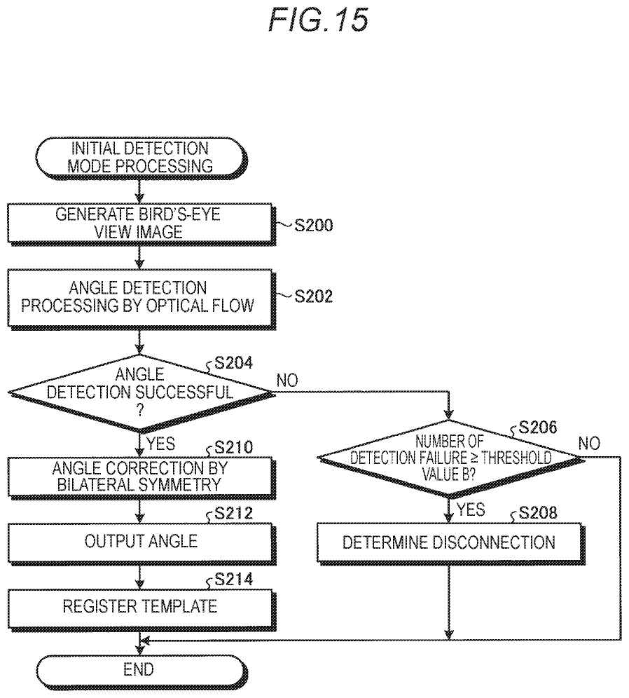

In S110, when the vehicle speed is maintained at the threshold value A or higher (Yes in S110), the periphery monitoring processing unit 50 starts the initial detection mode processing of the connection angle (S112). Details of the initial detection mode processing will be described using the flowchart of FIG. 15.

First, the image acquisition unit 52a sequentially acquires captured image data indicating the rear of the towing vehicle 10 captured by the imaging unit 24, and sequentially generates bird's-eye view image data by the bird's-eye view image generation unit 62 (S200). Subsequently, the detection processing of the connection angle by the optical flows is started (S202). That is, as illustrated in FIG. 6, the optical flow acquisition unit 64a calculates optical flows using data of a plurality of generated bird's-eye view images. Then, the search region setting unit 54a sets a plurality of turning search regions 72, and the counting unit 56a counts the number of short flows 70a. Based on the counting result of the counting unit 56a, the angle detection unit 56b detects (senses) the angle of the turning search region 72 having the largest count value of the short flows 70a as the connection angle between the towing vehicle 10 and the towed vehicle 12. When the connection angle is not successfully detected (No in S204), for example, when the count value of the short flows 70a is equal to or less than a predetermined threshold value, for example, when the number of short flows 70a is equal to or less than 20, the number of failures is counted as a detection error. Then, when the number of failures is less than a predetermined threshold value B (e.g., less than 5 times) (No in S206), this flow temporarily ends. On the other hand, when the number of failures reaches the predetermined threshold value B (e.g., five times) or more (Yes in S206), the angle detection unit 56b determines that the towed vehicle 12 is not connected to the towing vehicle 10 (S208), and this flow temporarily ends. In this case, the angle detection unit 56b notifies the output processing unit 60 of information on the disconnection of the towed vehicle 12, and the output processing unit 60 causes the display device 26 to display an icon or message notifying that the towed vehicle 12 is not connected via the display controller 36e. In addition, the output processing unit 60 may cause the voice output device 28 to output notification voice or a voice message notifying that the towed vehicle 12 is not connected via the voice controller 36f. In the angle detection processing of S202, using a histogram obtained by totaling the short flows 70a classified into the directional groups described in FIGS. 8 and 9 may contribute to a reduction in processing load or improvement in the accuracy of detection.

In S204, when the detection of the connection angle using the optical flows is successful (Yes in S204), the periphery monitoring processing unit 50 executes angle correction by bilateral symmetry as described in FIGS. 10 to 12 (S210). That is, the detailed search region setting unit 54b sets the detailed turning search region 74 at the interval of 0.1°, for example, in the range of ±5° about the connection angle detected in S202. Then, the division setting unit 54c executes a processing of dividing each detailed turning search region 74 into the first divided image 80a and the second divided image 80b to generate the search target images 76. The counting unit 56a counts the evaluation marks 82 of each of the generated search target images 76, and the detailed angle detection unit 56c detects the angle indicated by the detailed turning search region 74 corresponding to the search target image 76 having the largest count value as the connection angle (detailed connection angle) between the towing vehicle 10 and the towed vehicle 12 (S212). The detailed angle detection unit 56c provides the detected connection angle (detailed connection angle) to the output processing unit 60. Then, the template processing unit 58 registers, as a template, an image of the connection member 20 reflected in the detailed turning search region 74 corresponding to the connection angle (detailed connection angle) detected by the detailed angle detection unit 56c in the RAM 36c or the SSD 36d (S214), and this flow temporarily ends.

Returning to the flowchart of FIG. 14, when the initial detection mode processing of S112 ends and the template processing unit 58 has registered the template (Yes in S114), the reliability of the connection angle detected in the current detection processing is confirmed. For example, when variation in the connection angle detected in the current detection processing with respect to the connection angle detected in the past detection processing exceeds a predetermined threshold value C (No in S116), the flow returns to S112. For example, when the towed vehicle 12 is connected to the towing vehicle 10, the connection angle normally does not extremely vary within a period corresponding to the processing cycle of the detection processing. Thus, when variation between the connection angle detected in the current detection processing and the connection angle detected in the previous detection processing (e.g., a processing using an image one frame before) exceeds the threshold value C (e.g., 10°, it is determined that the reliability of the detected connection angle is low, and the initial detection mode processing using the optical flows is performed again.

In S116, when variation between the connection angle detected in the current detection processing and the connection angle detected in the previous detection processing is equal to or less than the predetermined threshold value C (Yes in S116), the periphery monitoring processing unit 50 determines that the connection angle detected by the initial detection mode processing is reliable. Then, the periphery monitoring processing unit 50 starts a simplified tracking detection mode processing using the connection angle detected by the initial detection mode processing as the detection processing of the connection mode at a next processing timing (S118).

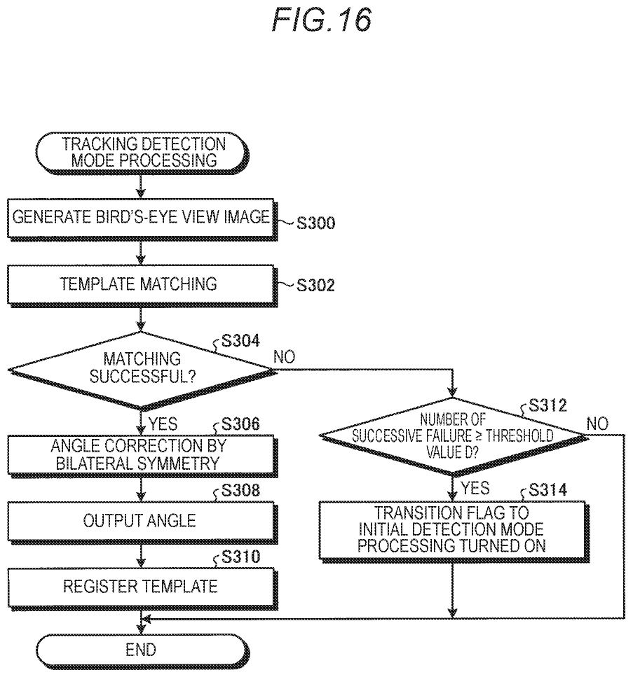

Details of the tracking detection mode processing will be described with reference to the flowchart of FIG. 16. First, the image acquisition unit 52a sequentially acquires captured image data indicating the rear of the towing vehicle 10 captured by the imaging unit 24, and sequentially generates bird's-eye view image data by the bird's-eye view image generation unit 62 (S300). Subsequently, the search region setting unit 54a sequentially superimposes a plurality of turning search regions 72 on the bird's-eye view image based on the generated bird's-eye view image data. Then, the angle detection unit 56b reads out the latest template registered in the RAM 36c or the SSD 36d by the template processing unit 58, and performs matching between an image reflected in each turning search region 72 and the template (S302). As described above, since the detection processing cycle of the connection angle is as short as 100 ms, for example, variation between the connection angle state of the connection member 20 detected in the initial detection mode processing and the connection angle state of the connection member 20 at the next processing timing may be regarded as slight. Thus, by selecting the turning search region 72 including an image that is most similar to the image of the connection member 20 registered as the template from among the plurality of turning search regions 72, the connection angle of the connection member 20 may be detected in the current detection processing. Determination of similarity in template matching may be executed using a known similarity calculation method such as, for example, SSD, SAD, or NCC. The angle detection unit 56b selects the turning search region 72 having the highest degree of similarity from among the turning search regions 72 for which the degree of similarity equal to or greater than a predetermined value is obtained.

When the template matching is successful (S304), the periphery monitoring processing unit 50 executes angle correction based on bilateral symmetry as described in FIGS. 10 to 12 (S306). That is, the detailed search region setting unit 54b sets the detailed turning search regions 74 at the interval of 0.1°, for example, in the range of ±5° about the angle of the turning search region 72 successfully matched in S304. Then, the division setting unit 54c performs a processing of dividing each detailed turning search region 74 into the first divided image 80a and the second divided image 80b to generate the search target images 76. The counting unit 56a performs counting of the evaluation marks 82 of each of the generated search target images 76, and the detailed angle detection unit 56c detects the angle indicated by the detailed turning search region 74 corresponding to the search target image 76 having the largest count value as the connection angle (detailed connection angle) between the towing vehicle 10 and the towed vehicle 12 (S308). The detailed angle detection unit 56c provides the detected connection angle (detailed connection angle) to the output processing unit 60. The template processing unit 58 registers (updates), as the latest template, the image of the connection member 20 reflected in the detailed turning search region 74 corresponding to the connection angle (detailed connection angle) detected by the detailed angle detection unit 56c in the RAM 36c or the SSD 36d (S310), and this flow temporarily ends.

In S304, when the template matching is not successful (No in S304), for example, when the similarity equal to or greater than a predetermined value is not obtained via matching with the plurality of turning search regions 72 set for the bird's-eye view image generated in the current processing, the number of failures is counted as a matching error. Then, when the number of detection failures is less than a predetermined threshold value D (e.g., less than 5 times) (No in S312), this flow temporarily ends. On the other hand, when the number of failures reaches the predetermined threshold value D (e.g., 5 times) or more (Yes in S312), the periphery monitoring processing unit 50 turns on a transition flag in order to shift to the initial detection mode processing and restart the initial detection (S314). In this case, for example, the periphery monitoring processing unit 50 determines that there is a possibility that the template registered in the previous processing is not appropriate, for example, that the detection of the connection angle has failed in the previous processing, and again performs acquisition of the template. In addition, as another possibility, for example, the periphery monitoring processing unit 50 determines that there is a possibility that the connection angle of the connection member 20 changes rapidly and the current template may not be applied, and again performs acquisition of the template.

As described above, by using the template based on the image reflected in the search target image 76 corresponding to the connection angle detected in the previous processing for the selection of the turning search region 72 in the current detection processing, the initial detection mode processing using the optical flows may be omitted, and the processing load may be reduced compared to the initial detection mode processing. In addition, using the template may contribute also to reduction in processing time.

Returning to the flowchart of FIG. 14, when the transition flag to the initial detection mode processing is turned on in the tracking detection mode processing (Yes in S120), the flow shifts to S112. On the other hand, in S120, when the transition flag to the initial detection mode processing is not turned on (No in S120), the periphery monitoring processing unit 50 determines whether or not a request for the trailer guide function is continued (S122). Then, when the request for the trailer guide function is continued (Yes in S122), the flow shifts to S118, and the tracking detection mode processing is executed at a next detection processing timing of the connection angle. On the other hand, when the request for the trailer guide function is not continued (No in S122), for example, when the user cancels the trailer guide function via the operation input unit 30, this flow ends.

In a case of performing angle correction based on bilateral symmetry adopted in the above-described initial detection mode processing or tracking detection mode processing, the symmetry between the first divided image 80a and the second divided image 80b is evaluated and the evaluation mark 82 is attached to the position that is evaluated as having symmetry. Then, the detailed angle detection unit 56c estimates that the search target image 76c having the largest count value of the evaluation mark 82 has a high possibility that the division line 78 and the longitudinal center line of the connection member 20 coincide with each other, and also estimates that the angle of the detailed turning search region 74c corresponding to the search target image 76c is the connection angle of the connection member 20. In this case, for example, when an appendage such as a cable extends from the connection member 20 and the appendage accidentally moves to a bilaterally symmetrical position, the evaluation mark 82 may also be attached to that portion and may be counted. As a result, an error may occur in the detection of the connection angle based on the count value of the evaluation mark 82.

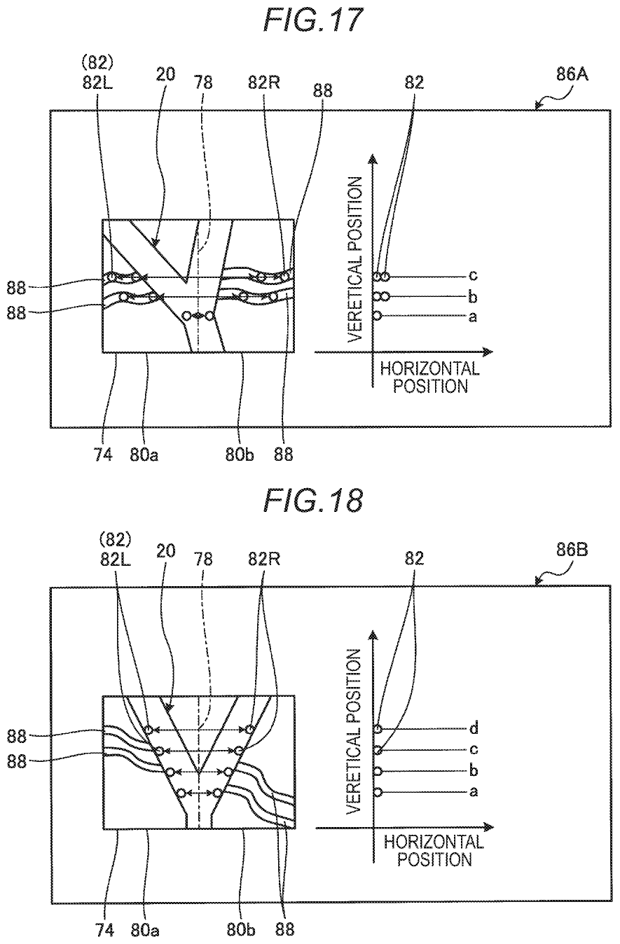

FIGS. 17 and 18 are exemplary and schematic views illustrating a case where the error as described above occurs and a countermeasure example thereof. A comparison pattern 86A illustrated in FIG. 17 is an example in which the connection member 20 is obliquely reflected in the detailed turning search region 74. That is, the comparison pattern 86A is an example in which the detailed turning search region 74 of FIG. 17 may not be regarded as the turning search region indicating the connection angle of the connection member 20. On the other hand, a comparison pattern 86B illustrated in FIG. 18 is an example in which the connection member 20 is reflected straightly in the detailed turning search region 74. That is, the comparison pattern 86B is an example in which the detailed turning search region 74 of FIG. 18 may be regarded as the turning search region indicating the connection angle of the connection member 20. In addition, in the examples of FIGS. 17 and 18, a plurality of non-fixed cables 88 extend in the vehicle width direction as an appendage of the connection member 20. In addition, in these examples, although the detailed turning search region 74 is divided into the first divided image 80a and the second divided image 80b by the division line 78, in this case, the second divided image 80b is not inverted. Thus, the detailed angle detection unit 56c evaluates similarity between bilaterally symmetrical positions with the division line 78 interposed therebetween, and adds the evaluation marks 82 to the positions that are evaluated as having symmetry.

In the example of FIG. 17, when evaluating similarity between the first divided image 80a and the second divided image 80b, five pairs of similar points 82L and 82R are detected with the division line 78 interposed therebetween. In this case, the counting unit 56a sets the count value of the evaluation mark 82 to “5”. On the other hand, in the example of FIG. 18, when evaluating similarity between the first divided image 80a and the second divided image 80b, four pairs of similar points 82L and 82R are detected with the division line 78 interposed therebetween. In this case, the counting unit 56a sets the count value of the evaluation mark 82 to “4”. As a result, the detailed angle detection unit 56c erroneously determines that the detailed turning search region 74 illustrated in FIG. 17 indicates the connection angle of the connection member 20.

The situation where such an erroneous determination occurs was analyzed. As a result, when indicating the angle at which the connection member 20 is bilaterally symmetrical, i.e., the connection angle at which the connection member 20 is reflected straightly in the detailed turning search region 74, the similar points 82L and 82R tend to be arranged in the direction in which the division line 78 extends regardless of the shape of the connection member 20. On the other hand, in the other detailed turning search region 74, the similar points 82L and 82R caused by the cable 88 or the shadow, for example, tend to be arranged in the direction orthogonal to the division line 78.

Therefore, the detailed angle detection unit 56c detects, as a symmetry evaluation value, the similar points 82L and 82R indicating the positions where similar portions exist in the first divided image 80a and the second divided image 80b, other than the count value of the evaluation mark 82. Then, the detailed angle detection unit 56c detects the number of evaluation lines which pass through the similar points 82L and 82R and extend in the direction orthogonal to the division line 78. In a case of FIG. 17, the number of evaluation marks 82 based on the similar points 82L and 82R is “5”, but the number of evaluation lines is “3” including evaluation lines a to c. On the other hand, in a case of FIG. 18, the number of evaluation marks 82 based on the similar points 82L and 82R is “4”, but the number of evaluation lines is “4” including evaluation lines a to d. Thus, the detailed angle detection unit 56c detects the angle corresponding to the detailed turning search region 74 having the maximum number of evaluation lines as the detailed connection angle of the towed vehicle 12 with respect to the towing vehicle 10, which enables a reduction in detection errors as described above. This determination may also be applied to a case where the second divided image 80b is inverted, and the same effects may be obtained.

As described above, according to the periphery monitoring processing unit 50 (periphery monitoring system 100) of the present embodiment, the processing of detecting the connection angle of the connection member 20 of the towed vehicle 12 may be performed with high accuracy without requiring preparation work for detecting the connection angle of the towed vehicle 12, for example, additional installation of a target mark, and without considering, for example, contamination of a detection target.

The example described above illustrates that the accuracy of detection is increased by converting the captured image data acquired by the imaging unit 24 into bird's-eye view image data and then performing each detection processing (determination processing). In another example, the actual image captured by the imaging unit 24 may be used as it is, and the detection processing (determination processing) may be similarly performed. In this case, the processing load may be reduced.

The embodiment described above illustrates an example in which, when executing the angle detection processing by the optical flows, it is necessary for the towing vehicle 10 (the towed vehicle 12) to move at a predetermined speed or more as a condition of executing the detection processing. When the towing vehicle 10 (towed vehicle 12) moves at a predetermined speed or more, moving point information and stop point information may be clearly identified and a stabilized angle detection processing may be realized, which may contribute to improvement in the accuracy of detection. In another embodiment, when a region other than the connection member 20 (e.g., a road surface region) satisfies a predetermined condition in the captured image, the angle detection processing by the optical flows may also be executed while the towing vehicle 10 (towed vehicle 12) is in the stop state (waiting). For example, in a case where the road surface serving as the background of the connection member 20 is an even plane and there is substantially no pattern, for example, due to difference in unevenness or difference in brightness, for example, similar point information (stop point information and feature point information) of the connection member 20 may be obtained by comparing a plurality of images acquired in time series. In such a case, as in the above-described embodiment, it is possible to count the number of pieces of similar point information and to enable detection of the connection angle, and the same effects may be obtained.

The periphery monitoring program executed by the CPU 36a of the present embodiment may be a file in an installable format or an executable format, and may be configured so as to be recorded and provided on a computer readable recording medium such as a CD-ROM, a flexible disk (FD), a CD-R, or a digital versatile disk (DVD).

Moreover, the periphery monitoring program may be configured so as to be stored on a computer connected to a network such as the Internet and be provided by being downloaded via the network. In addition, the periphery monitoring program executed in the present embodiment may be configured so as to be provided or distributed via a network such as the Internet.

A periphery monitoring device according to an aspect of this disclosure includes, for example, an image acquisition unit configured to sequentially acquire an image based on a captured image obtained by imaging a rear region of a towing vehicle that is captured by an imaging unit provided in the towing vehicle to which a towed vehicle is able to be connected, an information acquisition unit configured to acquire similar point information that satisfies a predetermined condition in one or more local regions with respect to a plurality of the images acquired in time series, a search region setting unit configured to set a plurality of turning search regions at a predetermined angular interval in a vehicle width direction about a connection element by which the towed vehicle is connected to the towing vehicle with respect to the acquired similar point information, and an angle detection unit configured to detect an angle corresponding to the turning search region in which a count value is maximum when a number of pieces of the similar point information is counted among the plurality of turning search regions as a connection angle of the towed vehicle with respect to the towing vehicle.

According to this configuration, for example, when the towed vehicle is connected to the towing vehicle, a relative positional relationship between the towing vehicle and the towed vehicle is substantially constant. That is, the similar point information (feature point information) indicating a portion corresponding to the towed vehicle obtained by comparing the plurality of captured images arranged in time series may be identified as a portion other than the towed vehicle. Thus, with respect to the plurality of turning search regions set at the predetermined angular interval in the vehicle width direction about the connection element of the towing vehicle, it is possible to estimate that the towed vehicle (or a portion thereof) is reflected in the turning search region including a large number of pieces of the similar point information that satisfies the predetermined condition, and the angle of the turning search region may be used as the connection angle of the towed vehicle. As a result, the connection angle of the towed vehicle may be detected with high accuracy without performing preparation work for detecting the connection angle of the towed vehicle, for example, attachment of the target mark.

In addition, for example, the periphery monitoring device according to the aspect of this disclosure may further include an own vehicle movement state acquisition unit configured to acquire own vehicle movement information indicating that the towing vehicle is moving, and, when it is determined that the towing vehicle is moving, the information acquisition unit may acquire moving point information that satisfies a predetermined condition in the local regions as the similar point information. When it is determined that the towed vehicle is connected to the towing vehicle and the towing vehicle is moving, a relative positional relationship between the towing vehicle and the towed vehicle in the traveling direction is substantially constant. According to this configuration, for example, variation in the moving point information of the portion corresponding to the towed vehicle obtained by comparing the plurality of images arranged in time series which are captured during traveling is less than variation in the moving point information of a portion other than the towed vehicle. Thus, with respect to the plurality of turning search regions set at the predetermined angular interval in the vehicle width direction about the connection element of the towing vehicle, it is possible to estimate that the towed vehicle (or a portion thereof) is reflected in the turning search region including a large number of pieces of the moving point information that satisfies the predetermined condition (e.g., moving point information having less variation), and the angle of the turning search region may be used as the connection angle of the towed vehicle. As a result, the connection angle of the towed vehicle may be detected with high accuracy.

In addition, for example, the information acquisition unit of the periphery monitoring device according to the aspect of this disclosure may acquire, as the similar point information that satisfies the predetermined condition, the moving point information indicating movement within a predetermined amount on a concentric orbit centered on the connection element and stop point information indicating that the towing vehicle is substantially in a stop state. According to this configuration, for example, when the towed vehicle is connected to the towing vehicle, the towed vehicle is allowed to move in a turning direction about the connection element, but movement thereof in a traveling direction (front-and-rear direction) is limited. Thus, the similar point information of the portion corresponding to the towed vehicle obtained by comparing the plurality of images arranged in time series which are captured during traveling may be the stop point information substantially indicating a stop mode or the moving point information indicating a moving mode on the concentric orbit centered on the connection element. Thus, the connection angle of the towed vehicle may be efficiently acquired by acquiring the similar point information that matches this condition.

In addition, for example, the angle detection unit of the periphery monitoring device according to the aspect of this disclosure may further include a connection determination unit configured to determine that the towed vehicle is not connected to the towing vehicle when a count value is equal to or less than a predetermined threshold value in any one of the plurality of turning search regions. According to this configuration, for example, disconnection of the towed vehicle may be detected in a processing of detecting the connection angle.

In addition, for example, the information acquisition unit of the periphery monitoring device according to the aspect of this disclosure may acquire a directional group classified for each movement direction indicated by the similar point information, and the detection unit may perform count of the count value with respect to the similar point information included in a predetermined number of high-rank directional groups in which a large number of movement directions are included in the directional group. According to this configuration, for example, when the connection angle of the towed vehicle varies, it is possible to narrow the range of a counting target of the similar point information by utilizing a fact that all similar point information (moving point information) indicates the same direction, which makes it possible a processing more efficient.

In addition, the image acquisition unit of the periphery monitoring device according to the aspect of this disclosure may acquire a bird's-eye view image on a basis of a height of the connection element based on the captured image. According to this configuration, for example, since it is possible to acquire the magnitude of movement or the direction of movement indicated by the moving point information on the basis of the height of the connection element to which the towed vehicle to be detected is connected, it is possible to determine the moving point information with higher accuracy, and the accuracy of detection of the connection angle may be improved.

In addition, for example, the search region setting unit of the periphery monitoring device according to the aspect of this disclosure may set a plurality of detailed turning search regions at an interval finer than the predetermined angular interval based on the connection angle detected by the angle detection unit, and the periphery monitoring device may further include a division setting unit configured to set a first divided image and a second divided image by dividing a search target image defined in each of the detailed turning search regions when the plurality of detailed turning search regions are superimposed on the image by a division line that passes through the connection element and extends in a longitudinal direction of the detailed turning search region, and a detailed angle detection unit configured to detect an angle corresponding to the detailed turning search region in which a symmetry evaluation value indicating symmetry between the first divided image and the second divided image with respect to the division line is maximum as a detailed connection angle of the towed vehicle with respect to the towing vehicle. A portion of the towed vehicle, for example, a connection member (connection bar) which interconnects the towing vehicle and the towed vehicle is often formed bilaterally symmetrically in consideration of tow balance. According to this configuration, for example, it is possible to detect the connection angle detected based on the similar point information as the detailed connection angle in the detailed turning search region using bilateral symmetry, and the accuracy of the connection angle may be improved.

In addition, for example, the search region setting unit of the periphery monitoring device according to the aspect of this disclosure may set a plurality of types of widths in a direction of a concentric orbit centered on the connection element of the detailed turning search region. According to this configuration, it is possible to detect the detailed connection angle using the detailed turning search region depending on the type (size or width) of a portion of the towed vehicle connected to the connection element, for example, the connection member (connection bar), which may contribute to improvement in the accuracy of detection.

In addition, for example, the division setting unit of the periphery monitoring device according to the aspect of this disclosure may invert one of the first divided image and the second divided image with the division line as an axis, and the detailed angle detection unit may evaluate symmetry using similarity between one inverted image and a remaining non-inverted image. According to this configuration, comparison of the first divided image and the second divided image is facilitated, which may contribute to reduction in processing load or reduction in processing time.

In addition, for example, the detailed angle detection unit of the periphery monitoring device according to the aspect of this disclosure may detect, as an evaluation value of the symmetry, a similar point indicating a position at which a similar portion between the first divided image and the second divided image exists, and may detect an angle corresponding to the detailed turning search region in which a number of evaluation lines is maximum as a detailed connection angle of the towed vehicle with respect to the towing vehicle when the evaluation lines are drawn to pass through the similar point and extend in a direction orthogonal to the division line of the detailed turning search region. For example, the connection member (connection bar) which interconnects the towing vehicle and the towed vehicle is often formed bilaterally symmetrically in consideration of tow balance and extends in a direction along the division line of the detailed turning search region. In this case, similar points are arranged in the direction in which the division line extends. Conversely, it may be estimated that similar points which are arranged in a direction different from the direction along the division line are likely to be similar points due to noise. According to this configuration, for example, the larger the number of evaluation lines passing through the similar points, the larger the number of similar points detected on the connection member (connection bar). As a result, for example, it is possible to detect the detailed connection angle with high accuracy compared to a case where the detailed connection angle is detected simply by counting the similar points.

Although the embodiments and modifications disclosed here have been exemplified above, the above-described embodiments and modifications thereof are merely given by way of example, and are not intended to limit the scope of this disclosure. Such novel embodiments and modifications may be implemented in various other modes, and various omissions, substitutions, combinations, and changes thereof may be made without departing from the gist of this disclosure. In addition, the embodiments and modifications may be included in the scope and gist of this disclosure and are included in the disclosure described in the claims and the equivalent scope thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A periphery monitoring device comprising:
an image acquisition unit configured to sequentially acquire an image based on a captured image obtained by imaging a rear region of a towing vehicle that is captured by an imaging unit provided in the towing vehicle to which a towed vehicle is able to be connected;
an information acquisition unit configured to acquire similar point information that satisfies a predetermined condition in one or more local regions with respect to a plurality of the images acquired in time series;
a search region setting unit configured to set a plurality of turning search regions at a predetermined angular interval in a vehicle width direction about a connection element by which the towed vehicle is connected to the towing vehicle with respect to the acquired similar point information; and
an angle detection unit configured to detect an angle corresponding to the turning search region in which a count value is maximum when a number of pieces of the similar point information is counted among the plurality of turning search regions as a connection angle of the towed vehicle with respect to the towing vehicle.

2. The periphery monitoring device according to claim 1, further comprising:
an own vehicle movement state acquisition unit configured to acquire own vehicle movement information indicating that the towing vehicle is moving,
wherein, when it is determined that the towing vehicle is moving, the information acquisition unit acquires moving point information that satisfies a predetermined condition in the local regions as the similar point information.

3. The periphery monitoring device according to claim 2, wherein
the information acquisition unit acquires, as the similar point information that satisfies the predetermined condition, the moving point information indicating movement within a predetermined amount on a concentric orbit centered on the connection element and stop point information indicating that the towing vehicle is substantially in a stop state.

4. The periphery monitoring device according to claim 1, further comprising:
a connection determination unit configured to determine that the towed vehicle is not connected to the towing vehicle when a count value is equal to or less than a predetermined threshold value in any one of the plurality of turning search regions.

5. The periphery monitoring device according to claim 2, wherein
the information acquisition unit acquires a directional group classified for each movement direction indicated by the similar point information, and
the detection unit performs count of the count value with respect to the similar point information included in a predetermined number of high-rank directional groups in which a large number of movement directions are included in the directional group.

6. The periphery monitoring device according to claim 1, wherein
the image acquisition unit acquires a bird's-eye view image on a basis of a height of the connection element based on the captured image.

7. The periphery monitoring device according to claim 1, wherein
the search region setting unit sets a plurality of detailed turning search regions at an interval finer than the predetermined angular interval based on the connection angle detected by the angle detection unit, and
the periphery monitoring device further comprises:
a division setting unit configured to set a first divided image and a second divided image by dividing a search target image defined in each of the detailed turning search regions when the plurality of detailed turning search regions are superimposed on the image by a division line that passes through the connection element and extends in a longitudinal direction of the detailed turning search region; and
a detailed angle detection unit configured to detect an angle corresponding to the detailed turning search region in which a symmetry evaluation value indicating symmetry between the first divided image and the second divided image with respect to the division line is maximum as a detailed connection angle of the towed vehicle with respect to the towing vehicle.

8. The periphery monitoring device according to claim 7, wherein
the search region setting unit sets a plurality of types of widths in a direction of a concentric orbit centered on the connection element of the detailed turning search region.

9. The periphery monitoring device according to claim 7, wherein
the division setting unit inverts one of the first divided image and the second divided image with the division line as an axis, and
the detailed angle detection unit evaluates symmetry using similarity between one inverted image and a remaining non-inverted image.

10. The periphery monitoring device according to claim 7, wherein
the detailed angle detection unit detects, as an evaluation value of the symmetry, a similar point indicating a position at which a similar portion between the first divided image and the second divided image exists, and detects an angle corresponding to the detailed turning search region in which a number of evaluation lines is maximum as a detailed connection angle of the towed vehicle with respect to the towing vehicle when the evaluation lines are drawn to pass through the similar point and extend in a direction orthogonal to the division line of the detailed turning search region.
